(19) United States
(12) Patent Application Publication
(10) Pub. No.: US 2007/0166025 A1
(43) Pub. Date: Jul. 19, 2007

(54) IMAGE PICK-UP APPARATUS AND METHOD USING THE SAME

(75) Inventor: WEI-CHUNG CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,652

(22) Filed: Sep. 5, 2006

(30) Foreign Application Priority Data
Jan. 13, 2006 (CN) 200610032960.1

(51) Int. Cl. G03B 17/00

(52) U.S. Cl. 396/529

(57) ABSTRACT

An exemplary image pick-up apparatus and method, facilitating the provision of excellent images, are provided. The apparatus includes: a lens assembly, an image sensor, a detection unit, a data memory unit, a control unit, and a processor unit. The lens assembly is configured for picking up optical information representative of a target. The image sensor is configured for producing electronic signals corresponding to the optical information. The detection unit is configured for detecting operational parameters of the lens assembly in operation. The data memory unit is configured for supplying aberration corrections relevant to the operational parameters. The control unit is configured for receiving the operational parameters and for retrieving aberration corrections from the data memory unit to build/generate correction parameters. The processor unit is configured for receiving the electronic signals and the correction parameters, upon which images are created and output thereby.

### FIELD OF THE INVENTION

This invention relates generally to an optical imaging field and, more particularly, to digital image pick-up apparatuses and methods with favorable aberration correction, such as chromatic aberrations and/or monochromatic aberrations.

### DESCRIPTION OF RELATED ART

Typically, a digital image pick-up apparatus, such as a video camera or a digital still camera, includes a zoom lens assembly, an image sensor (e.g., a charge-coupled device or a complementary metal-oxide semiconductor device), and an image-processing unit. When the digital imaging system is in operation, the zoom lens assembly picks up optical information representative of an object. The optical information is sensed by means of the image sensor and electronic signals corresponding to the optical information are produced. The electronic signals are processed by means of the image-processing unit (e.g., a digital signal processor, DSP) and an image corresponding to the electronic signals is created as an output. Thereafter, the created image can be stored and/or displayed. Some problems associated with the zoom lens assembly include optical aberrations, such as lateral chromatic aberration and distortion, which will result in degradation of quality of the created image.

Generally, in an optical design stage of such a zoom lens assembly, in order to achieve a relatively high quality created image, optical aberrations occurring in various zooming states of the zoom lens assembly are simulated by a simulation software to get a balanced value thereof. Thus, a resultant configuration of the zoom lens assembly can be obtained corresponding to the balanced value. However, optical aberrations, especially lateral chromatic aberration and distortion, usually vary with effective focal length, as lenses in the zoom lens assembly physically move during a zoom operation. Such aberration variance based on effective focal length tends to make the image quality created by the image pick-up apparatus incorporating the zoom lens assembly unsatisfactory.

What is needed is to provide an image pick-up apparatus and method with favorable aberration correction, especially lateral chromatic aberration and distortion.

### SUMMARY OF THE INVENTION

An image pick-up apparatus in accordance with a preferred embodiment is provided. The image pick-up apparatus includes: a lens assembly, an image sensor, a detection unit, a data memory unit, a control unit, and a processor unit. The lens assembly is configured (i.e., structured and arranged) for picking up optical information representative of a target. The image sensor is configured for producing electronic signals corresponding to the optical information. The detection unit is configured for detecting operational parameters of the lens assembly during operation thereof. The data memory unit is configured for supplying at least one aberration correction relevant to the operational parameters. The control unit is configured for receiving the operational parameters and retrieving the at least one aberration correction from the data memory unit and for building/generating correction parameters based on the at least one aberration correction. The processor unit is configured for receiving the electronic signals from the image sensor and the correction parameters from the control unit, upon which images are created as output.

An image pick-up method in accordance with a related preferred embodiment is provided. The image pick-up method includes the following steps:
a) picking up optical information representative of a target, through a lens assembly;
b) producing electronic signals in an image sensor, wherein the electronic signals correspond to the optical information;
c) detecting an operational parameter of the lens assembly during the picking up step;
d) finding at least one aberration correction from a data memory unit based upon the operational parameter and building a correction parameter based on the at least one aberration correction; and
e) creating an image in a processor unit based upon the electronic signals and the correction parameter, the image being an output of the processor unit.

The image pick-up apparatus and method in accordance with the preferred embodiments can promote the creation of a relatively high quality image with favorable aberration correction, as the detection unit, the data memory unit, and control unit cooperatively build a corresponding aberration correction for facilitating the processor unit to create a high quality image.

Other advantages and novel features will become more apparent from the following detailed description of embodiments when taken in conjunction with the accompanying drawings.

### BRIEF DESCRIPTION OF THE DRAWINGS

Many aspects of the present image pick-up apparatus and method can be better understood with reference to the following drawings. The components in the drawings are not necessarily drawn to scale, the emphasis instead being placed upon clearly illustrating the principles of the present apparatus and method. Moreover, in the drawings, like reference numerals designate corresponding parts throughout the several views.

FIG. 1 is a simplified functional block diagram of an image pick-up apparatus, in accordance with a preferred embodiment.

The exemplifications set out herein illustrate at least one preferred embodiment, in one form, and such exemplifications are not to be construed as limiting the scope of the present image pick-up apparatus and method in any manner.

### DETAILED DESCRIPTION OF THE INVENTION

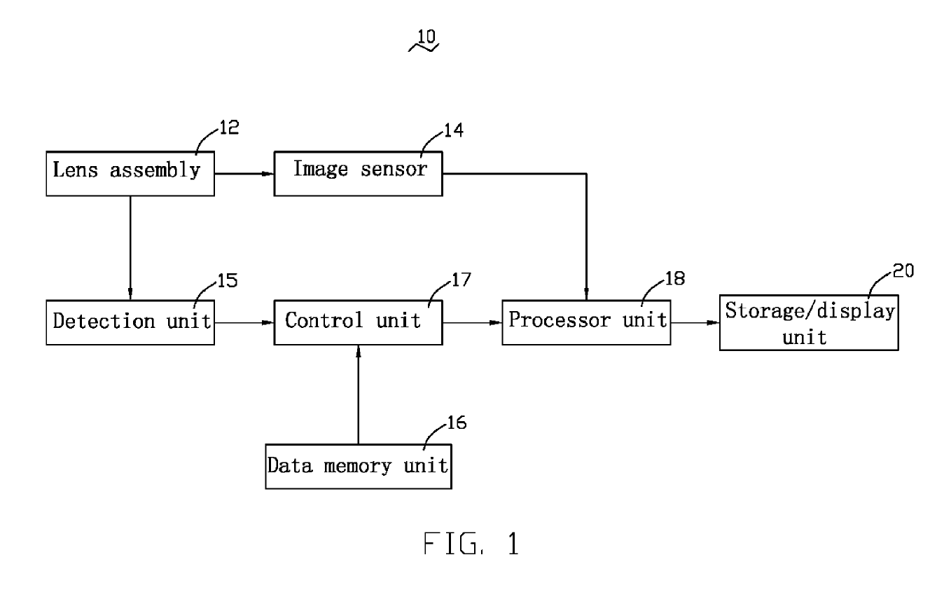

Referring to FIG. 1, a simplified functional block diagram of an image pick-up apparatus 10, in accordance with a preferred embodiment, is provided. The image pick-up apparatus 10 includes: a lens assembly 12, an image sensor 14, a detection unit 15, a data memory unit 16, a control unit 17, a processor unit 18, and a storage/display unit 20.

The lens assembly 12 is configured (i.e., structured and arranged) for picking up optical information representative of a target. The lens assembly 12 is provided having at least one lens for focusing light reflected from the target incident on the image sensor 14. In the illustrated embodiment, the lens assembly 12 can be, e.g., a well-known zoom lens assembly, such as a two-group zoom lens assembly, a three-group zoom lens assembly, etc. Additionally, the lens assembly 12 could incorporate a digital zoom.

The image sensor 14 is configured for producing electronic signals corresponding to the optical information picked up by the lens assembly 12. The image sensor 14 can be a CCD (charge-coupled device) active pixel array device or another suitable sensor, e.g., a CMOS (complementary metal oxide semiconductor) active pixel array device. A CCD active pixel array device and a CMOS active pixel array device each generally include a two-dimensional pixel array.

The detection unit 15 is configured for detecting operational parameters of the lens assembly 12 while the lens assembly 12 picks up optical information. The detection unit 15 can, for example, be a position sensor, which can detect at least one operational parameter of the lens assembly 12, e.g. an effective focal length (EFL).

The data memory unit 16 includes a database recording a number of aberration corrections, e.g., corrections of chromatic aberrations and monochromatic aberrations relevant to values of the at least one operational parameter of the lens assembly 12. These values are measured during the zooming of the lens assembly 12 from the wide-angle end/position thereof to the telephoto end thereof. The aberration corrections can be obtained from a manufacturer of the lens assembly 12. Commonly, in an optical design stage of such a lens assembly 12, in order to obtain a lens assembly with favorable aberration corrections, especially with respect to lateral chromatic aberration and/or distortion, the manufacturer will simulate aberrations occurring in the lens assembly 12. Such simulations will be made over the operating range of the lens assembly 12, zooming from the wide-angle end to the telephoto end, i.e., whilst the lens assembly 12 operates at different effective focal lengths. Therefore, the aberration corrections for the lens assembly 12 at different effective focal lengths can be calculated based upon the above-mentioned properties associated with aberrations.

The control unit 17 is configured for receiving the operational parameters detected by the detection unit 15 and for retrieving aberration corrections corresponding to the operational parameters from the data memory unit 16. The aberration corrections obtained from the data memory unit 16 are analyzed by circuitry/software in the control unit 17, thus building correction parameters.

The processor unit 18 is configured for receiving electronic signals produced by the image sensor 14 and the correction parameters outputted from the control unit 17, upon which images are created as output. The processor unit 18 can, e.g., be any well-known digital signal processor (DSP) or image signal processor (ISP). Due to a correction using corresponding correction parameters, images with favorable aberration correction, especially with respect to lateral chromatic aberration and/or distortion, can be achieved.

The storage/display unit 20 is configured for storing and/or displaying the images outputted from the processor unit 18. The storage/display unit 20 can be a memory, a display device, or an assembly/combination of a memory and a display device.

An exemplary image pick-up method using the above-mentioned image pick-up apparatus 10 will be described below with reference to FIG. 1, with arrows in FIG. 1 illustrating the transmission directions of signals.

The lens assembly 12 picks up optical information representative of a target in a zooming/focusing state thereof. The optical information representative of the target is sensed via the image sensor 14, whereby electronic signals corresponding to the optical information are produced. An operational parameter (e.g. an effective focal length) of the lens assembly 12, operating at the zooming state, is detected via the detection unit 15. The operational parameter then is captured by the control unit 17. A searching function is carried out by the control unit 17, and a corresponding aberration correction is obtained from the data memory unit 16. Accordingly, a correction parameter is then built/generated by the control unit 17. The electronic signals and the correction parameter are simultaneously sent to the processor unit 18, whereby an image with a favorable aberration correction is created as an output. Thereafter, the created image can be stored and/or displayed through the storage/display unit 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. An image pick-up apparatus, comprising:
a lens assembly configured for picking up optical information representative of a target;
an image sensor configured for producing electronic signals corresponding to the optical information;
a detection unit configured for detecting operational parameters of the lens assembly during operation thereof;
a data memory unit configured for supplying at least one aberration correction relevant to the operational parameters;
a control unit configured for receiving the operational parameters, for retrieving the at least one aberration correction from the data memory unit, and for generating correction parameters based on the at least one aberration correction; and
a processor unit configured for receiving the electronic signals from the image sensor and the correction parameters from the control unit, in order to thereby create images as output.

2. The image pick-up apparatus of claim 1, further comprising a storage/display unit configured for storing and/or displaying the image outputted from the processor unit.

3. The image pick-up apparatus of claim 1, wherein the lens assembly is a zoom lens assembly.

4. The image pick-up apparatus of claim 1, wherein an operational parameter to be detected is an effective focal length of the lens assembly, the detection unit comprising a position sensor structured and arranged for detecting a range of such effective focal lengths of the lens assembly, during operation thereof.

5. An image pick-up method, comprising the following steps of:
picking up optical information representative of a target, the optical information being picked up through a lens assembly;
producing electronic signals in an image sensor, wherein the electronic signals correspond to the optical information;
detecting an operational parameter of the lens assembly during the picking up step;
retrieving at least one aberration correction from a data memory unit based upon the operational parameter and subsequently generating a correction parameter based on the at least one aberration correction; and
creating an image as an output in a processor unit, the image being based upon the electronic signals and the correction parameter received by the processor unit.

6. The image pick-up method of claim 5, wherein the operational parameter comprises an effective focal length of the lens assembly.

7. The image pick-up method of claim 5, wherein the at least one aberration correction comprises at least one of a correction of a chromatic aberration and a correction of a monochromatic aberration.

8. The image pick-up method of claim 7, wherein one aberration correction comprises a correction of a chromatic aberration, the correction of the chromatic aberration being a correction of a lateral chromatic aberration.

9. The image pick-up method of claim 7, wherein one aberration correction comprises a correction of a monochromatic aberration, the correction of the monochromatic aberration being a correction of a distortion.
